(19) United States
(12) Patent Application Publication
(10) Pub. No.: US 2005/0240861 A1
(43) Pub. Date: Oct. 27, 2005

(54) Computer-based method and system for analyzing and presenting court dockets

(76) Inventors: Gregory E. Upchurch, Manchester, MO (US); David S. Guard, St. Louis, MO (US)

Correspondence Address: HUSCH & EPPENBERGER, LLC, 190 CARONDELET PLAZA, SUITE 600, ST. LOUIS, MO, 63105-3441, US

(21) Appl. No.: 10/828,652

(22) Filed: Apr. 21, 2004

(51) Int. Cl. G06F 17/00

(52) U.S. Cl. 715/509; 715/501.1; 715/764; 707/102

(57) ABSTRACT

An electronic court docket includes embedded tables illustrating subsequent activity relating to docket entries. A method of analyzing the dockets and preparing the embedded tables includes identifying associated entries, preparing a table for each primary entry having associated entries, and inserting each table adjacent its primary entry.

### CROSS-REFERENCES TO RELATED APPLICATIONS

None.

### STATEMENT REGARDING FEDERALLY SPONSORED RESEARCH OR DEVELOPMENT

Not applicable.

### BACKGROUND OF THE INVENTION

1. Field of the Invention

This invention relates to the analysis and display of court docket entries, and in particular to computer-implemented analysis and display of court docket entries that facilitate use of said docket entries by a human user.

2. Prior Art

Court docket information is available for many courts. This docket information is typically in the form of individual docket entries representing actual documents filed in the case and activity by or in court concerning the case (such as entries reflecting hearings held, trials, etc.) Some of this docket information is available in electronic form. For example, for most federal courts the official dockets are available through the PACER system or the more-recently developed ECF system.

The electronically available dockets are helpful to the practitioner, but they could be improved. For example, in a court case with a great deal of activity (the dockets that are of the most interest) the interesting motions and decisions are often difficult to find because of the much larger number of unimportant docket entries reflecting requests for additional time to file papers and the like. Even when the docket is available for searching in electronic form, the important motions and orders still take an unnecessarily long amount of time to find because of all the relatively unimportant motions and orders present in the docket. Moreover, it is often difficult to determine whether a particular motion of interest (a summary judgment motion, for example) has been ruled on, using conventional electronic dockets. This difficulty is compounded when the docket is examined in paper form.

### BRIEF SUMMARY OF THE INVENTION

In a first aspect of the present invention, a method of analyzing court docket information to facilitate the use of said information includes obtaining a court docket in electronic form, identifying entries in the docket associated with a primary entry, inserting in the electronic form of the docket a table of associated entries adjacent the primary entry, so that visual display of the electronic form of the court docket discloses to a human user the docket entries associated with the primary entry.

In a second aspect of the present invention, an electronic data structure representing court docket information includes a computer memory having stored therein data representing docket entries, said entries including at least one primary entry and at least one associated entry associated with said primary entry and at least one table of associated docket entries for at least one case.

In a third aspect of the present invention, a method of using court docket information includes obtaining a court docket in electronic form, identifying entries in the docket associated with a primary entry, inserting in the electronic form of the docket a table of associated entries adjacent the primary entry corresponding thereto such that display of the electronic form of the court docket includes display of the table of associated entries, and graphically displaying the court docket in electronic form such that the table of associated entries is displayed adjacent said primary entry.

In a fourth aspect of the present invention, a computer data signal representing court docket information includes a docket entry segment comprising court docket entries for at least one case in electronic form, a table segment comprising a table identifying associated entries for one of the docket entries, said table segment being disposed such that upon display of the computer data signal said table segment is displayed adjacent said one of the docket entries.

Among the various objects and features of the present invention may be noted the provision of an improved method for analyzing court dockets.

Another object and feature is the provision of an improved court docket that facilitates the location of important information in the docket.

A third object and feature is the provision of a method of displaying court dockets that highlights the location of important information.

A fourth object and feature is the provision of a system and method that highlights the activity resulting from various motions.

Other objects and features will become apparent from consideration of the ensuing description and drawings.

### BRIEF DESCRIPTION OF THE DRAWINGS

FIG. 1 is a block diagram illustrating sources of information and analysis for the present invention, and communication of the analyzed information to a user's computer.

FIG. 2 is a flowchart of the analysis performed by one of the computers shown in FIG. 1.

FIG. 3 is an illustration of a graphical display of an electronic court docket of the present invention.

FIG. 4 illustrates a graphical display of an electronic court docket without the present invention.

FIG. 5 illustrates a graphical display of an electronic court docket incorporating the present invention.

FIG. 6 is a flowchart illustrating an optional feature of the present invention.

FIGS. 7 and 8 are graphical displays illustrating the feature of FIG. 6.

Similar reference characters indicate similar parts throughout the several views of the drawings.

### DETAILED DESCRIPTION OF THE INVENTION

FIG. 1 illustrates the major components of one aspect of the present invention. In this aspect, electronic court docket information is obtained from a source computer 11. The source computer can be a computer controlled by the court which provides docket information to the public, such as that available from the federal courts through the PACER and ECF systems. Alternatively, the electronic docket information can be obtained from a commercial source of dockets, by scanning paper dockets, or in any other suitable manner.

The electronic docket information is typically in the form of (a) header information, reflecting information about the court case such as party names, type of suit, attorney names, jurisdictional basis for the suit, and the like, and (b) docket entries, containing the record (typically entered by the clerk) as to filings and hearings in the case.

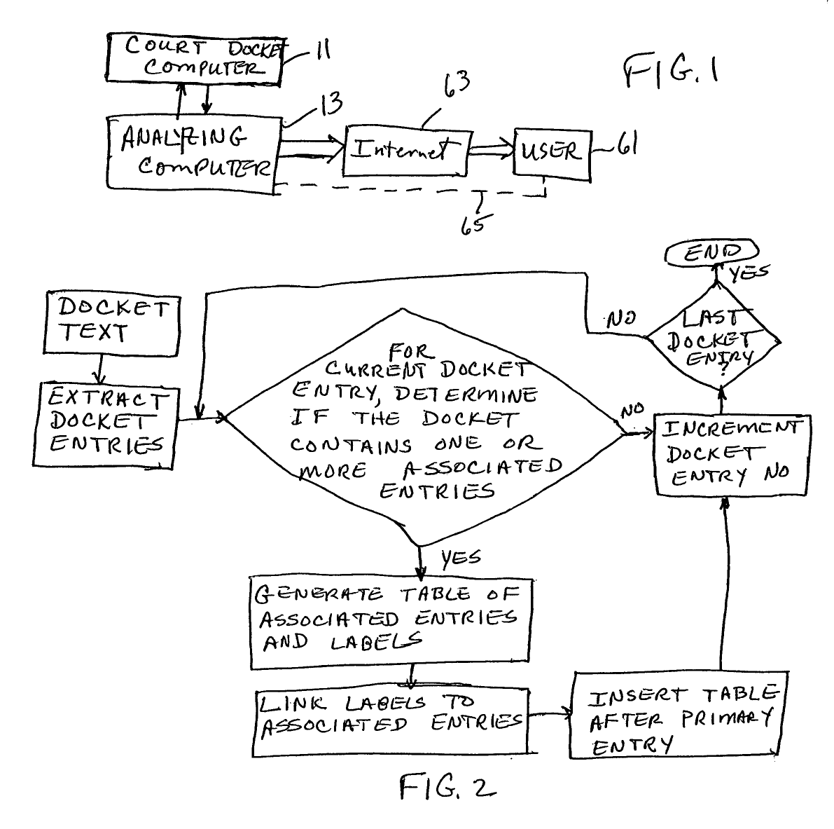

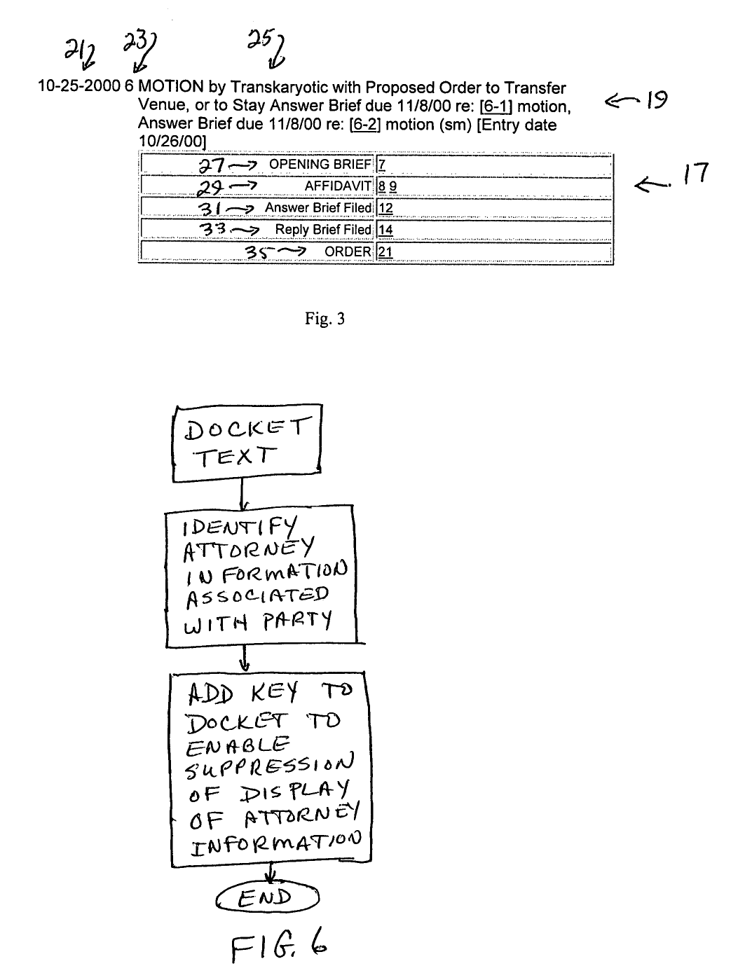

The electronic docket information, from whatever source, is supplied to an analyzing computer 13. Computer 13 is a conventional computer programmed to perform the following steps (illustrated in FIG. 2). The docket entries are analyzed by computer 13 to determine if an entry has other entries associated with it. For example, a motion to transfer could have several documents associated with it, such as a brief, affidavits, answering and reply briefs, and one or more orders. See, e.g., FIG. 3.

Computer 13 analyzes each docket entry (whether the court assigns a docket sequence number to the entry or not) in turn to determine if it relates back to a previous entry. The entries which relate back, such as answering briefs and orders, are called associated entries, while the previous entry (the one to which the associated entries relate) is called a primary entry. (As an alternative to determining primary and associated entries automatically, they could be determined manually or semi-automatically and input into computer 13.)

It has been found that many times the federal courts will provide a numerical reference in the associated docket entry to the primary entry. In those cases computer 13 identifies those references and creates the desired electronic association. Of course, other processing (or manual input) could be used as well to identify associated entries if it is desired to provide associations that are more complete than those provided by the court in entering the information. The present invention does not require that all the associations be identified, so using the reference information in the docket entries is usually sufficient.

Once the associated entries have been identified for the primary entries, it is preferred that a table (e.g., table 17 in FIG. 3) showing those associated entries be inserted into the electronic form of the docket. Preferably the table for a particular primary entry is inserted in the electronic docket immediately after that primary entry. For example, in FIG. 3, table 17 is disposed immediately below the relevant docket entry 19. As is conventional, the docket entry includes a docket entry date 21 reflecting the date the document was filed, a docket sequence number 23, and the docket entry text 25. As shown in FIG. 3, the table 17 includes a brief label specifying the nature of the associated entries for each associated entry. For example, in FIG. 3, the associated entries have labels 27 (Opening Brief), 29 (Affidavit), 31 (Answer Brief Filed), 33 (Reply Brief Filed), and 35 (Order). Different labels could of course be used.

The table also preferably includes the sequence numbers of the associated docket entries so that the viewer can immediately determine not only what activity has occurred with respect to the primary entry, but also where that activity is found in the docket. Although this is relatively trivial when the associated entries reflect the Opening Brief and Affidavits (found as sequence numbers 7, 8 and 9 respectively), it is not trivial when the associated entry is found some distance in the docket away from the primary entry. An example of this is the Order found at sequence number 21, which is fifteen docket entries away from the primary docket entry found at sequence number 6. Many times the relevant associated entries can be scores of entries away from the primary entry.

If desired, the sequence numbers for the associated entries (or the associated entries themselves) can provide hypertext links directly to the docket entries. Conversely, hypertext links in the associated entries can be provided to link directly back to the primary entry.

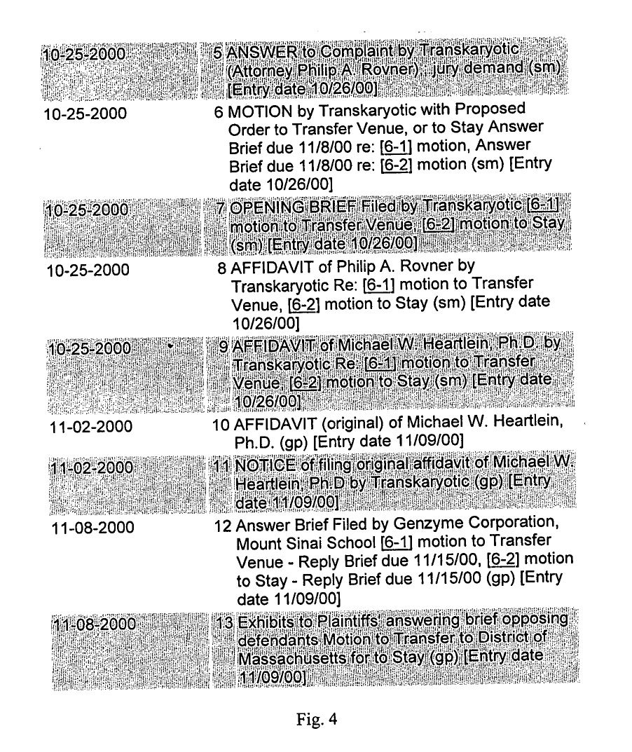

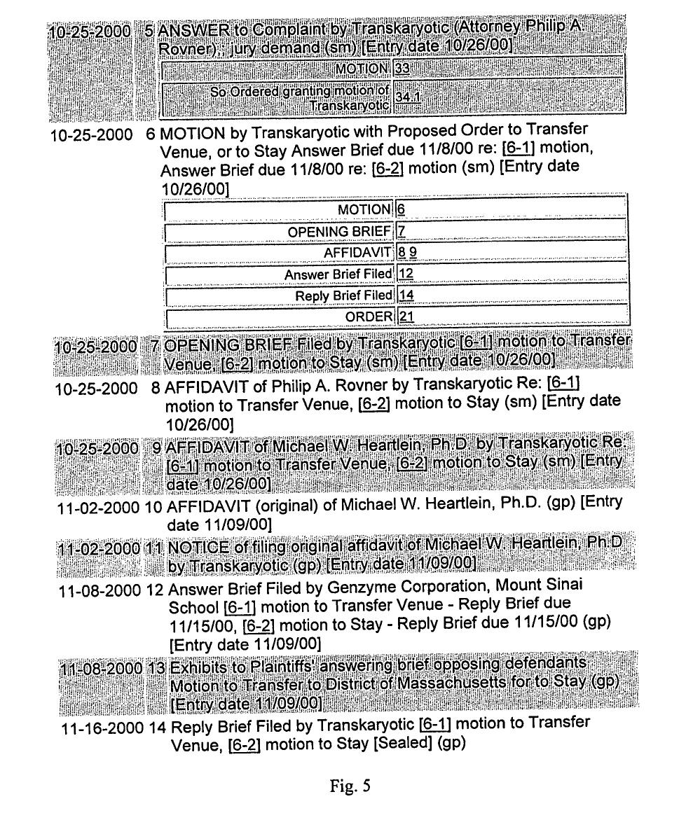

Creating an electronic form of the docket in the form illustrated in FIG. 3 has some significant advantages. A viewer of a docket in this form immediately sees which docket entries have had activity, and which have not. Moreover, the table also gives a quick overview of what particular activity has taken place. This can be seen in FIG. 4 in which a portion of a court docket without this feature is shown. This should be compared with FIG. 5 that shows the same docket entries with the feature of the present invention included. Not only docket entry sequence number 6 is immediately seen to have had activity, but also docket entry sequence number 5. Moreover, that activity is plainly identified to the viewer. Links are preferably provided to link directly to the associated entries.

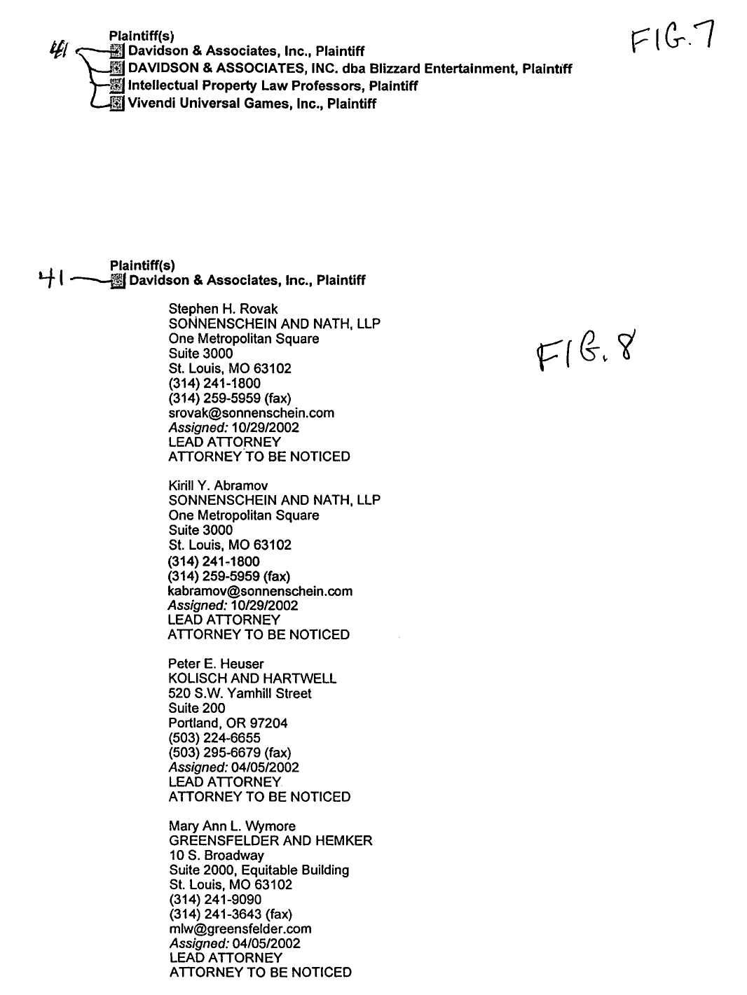

The dockets often have considerable information other than docket entries. For example, the attorneys for each party are usually identified in the dockets. It makes the electronic form of the docket more readable if the attorney information could be suppressed, if desired. This is illustrated by the flowchart in FIG. 6 that illustrates the steps computer 13 takes in this regard. Specifically, the docket text for each docket is analyzed to identify attorney information (usually at least the attorney name, address and telephone number for each attorney who has entered an appearance). Computer 13 adds a button 41 (see FIG. 7) adjacent the party names on the electronic docket to allow the viewer to suppress the attorney information as desired. In response to a viewer input indicative of pressing button 41, computer 13 causes the display of the attorney information to be either suppressed (if it was being displayed) or enabled (if it was being suppressed). Compare FIGS. 7 (attorney information suppressed) and 8 (attorney information for one plaintiff not suppressed) to observe the difference in legibility that can result from this feature.

Turning back to FIG. 1, computer 13 (or another suitable computer in communication with computer 13) provides a computer data signal representing the electronic docket information, including the table feature of the present invention, to a user's computer 61. This signal can be supplied over the Internet 63 in conventional manner, or by any known alternative electronic delivery system (indicated by dashed line 65.

Although the description above contains many specifics, these should not be construed as limiting the scope of the invention but as merely providing illustrations of some of the currently preferred embodiments of the invention. The scope of the invention should be determined by the appended claims and their legal equivalents, rather than by the examples given.

1. A method of analyzing court docket information to facilitate the use of said information comprising:
obtaining a court docket in electronic form;
identifying entries in the docket associated with a primary entry;
inserting in the electronic form of the docket a table of associated entries adjacent the primary entry;
so that visual display of the electronic form of the court docket discloses to a human user the docket entries associated with the primary entry.

2. The method as set forth in claim 1 further including identifying label in the table for each of the associated docket entries.

3. The method as set forth in claim 1 further including inserting links in the table to the associated entries.

4. The method as set forth in claim 1 wherein the court docket includes attorney identifying information, further including the step of enabling suppression of said attorney identifying information.

5. The method as set forth in claim 1 wherein the associated entries are identified by use of a number code contained in the court docket information.

6. The method as set forth in claim 1 wherein the table is inserted after the primary entry.

7. An electronic data structure representing court docket information comprising:
a computer memory having stored therein data representing docket entries, said entries including at least one primary entry and at least one associated entry associated with said primary entry and at least one table of associated docket entries for at least one case.

8. The electronic data structure as set forth in claim 7 wherein the data representing said table includes data representing identifying labels for the associated docket entries.

9. The electronic data structure as set forth in claim 7 wherein the data representing said table includes data representing links to said associated docket entries.

10. The electronic data structure as set forth in claim 7 wherein the data structure includes data representing a plurality of tables, each table corresponding to a unique primary docket entry and containing associated entries for said corresponding primary docket entry so that a plurality of primary docket entries have tables corresponding thereto.

11. A method of using court docket information comprising:
obtaining a court docket in electronic form;
identifying entries in the docket associated with a primary entry;
inserting in the electronic form of the docket a table of associated entries adjacent the primary entry corresponding thereto such that display of the electronic form of the court docket includes display of the table of associated entries.

12. A computer data signal representing court docket information comprising:
a docket entry segment comprising court docket entries for at least one case in electronic form;
a table segment comprising a table identifying associated entries for one of the docket entries;
said table segment being disposed such that upon display of the computer data signal said table segment is displayed adjacent said one of the docket entries.
